(19) United States
(12) Patent Application Publication
(10) Pub. No.: US 2023/0161361 A1
(43) Pub. Date: May 25, 2023

(54) DEVICE FOR CONTROLLING TRAVEL OF MOVING BODY

(71) Applicant: OMOROBOT CO., LTD., Ansan-si (KR)

(72) Inventor: Seok Hoon YOON, Danwon-gu (KR)

(73) Assignee: OMOROBOT CO., LTD., Ansan-si (KR)

(21) Appl. No.: 18/154,527

(22) Filed: Jan. 13, 2023

Related U.S. Application Data
(63) Continuation of application No. PCT/KR2020/009237, filed on Jul. 14, 2020.

(51) Int. Cl. G05D 1/12; G05D 1/02

(52) U.S. Cl. CPC G05D 1/12; G05D 1/0223; G05D 1/0272

(57) ABSTRACT

A device for controlling the travel of a moving body according to the present invention may be fixed at a certain position of the moving body. The device comprises: a wire which has one end accommodated inside and the other end extending outward and fixed to a certain position on a user, wherein the wire winds or unwinds in a straight line with tension according to the movement of the user, and a control signal generation unit which generates a control signal for controlling the travel of the moving body.

### CROSS-REFERENCE TO RELATED APPLICATIONS

The present application is a continuation of International Patent Application No. PCT/KR2020/009237, filed on Jul. 14, 2020. The disclosure of the above-listed application is hereby incorporated by reference herein in their entirety.

### TECHNICAL FIELD

The present disclosure relates to a driving control apparatus for a moving object, which can control the moving object to be driven while keeping a predetermined distance from a user.

### BACKGROUND ART

Recently, as unmanned and automated systems of manufacturing processes have been noticeably increased with the advancement of industrial society, desires to minimize human intervention in cargo transfer processes have spread. To cope with such desires, various transfer device technologies based on autonomous driving, such as unmanned transfer carriers accommodating cargos and performing autonomous driving, have emerged.

Transfer equipment in the related art including transfer equipment disclosed in Korean Patent No. 1,227,160 relates to an autonomous driving system through sensing of guide rails, conveyer belts, and the like, which are usually formed along a driving route, and may be applied to large production lines or processes for mass production to improve the work efficiency. However, the transfer equipment in the related art has technical and economical limits in applying the transfer equipment to small work sites or to the transfer of relatively small and lightweight products, and it is difficult for general users to utilize the transfer equipment at other places other than the work sites.

Accordingly, in order to solve the above-described problems of the transfer equipment in the related art, the present inventor has invented a driving control apparatus for a moving object, which can easily control the moving object that transfers a relatively small and lightweight object, such as a shopping cart or a stroller, and can be implemented at low costs, as well.

### PRIOR ART DOCUMENT

### Patent Document

Korean Patent No. 1,227,160

### DISCLOSURE

### Technical Problem

In order to solve the above-described problems, the present disclosure is to provide a driving control apparatus for a moving object, which can easily control the moving object that transfers a relatively small and lightweight object, and can be implemented at low costs as well.

Further, the present disclosure is to provide a driving control apparatus for a moving object, which can control the moving object to be driven while keeping a predetermined distance from a user.

Further, the present disclosure is to provide a driving control apparatus for a moving object, which can provide various driving modes in which a location relationship between a user and the moving object is defined, and can easily control the moving object in accordance with the driving mode selected by the user.

### Technical Solution

A driving control apparatus for a moving object according to the present disclosure may be fixed to a predetermined location of the moving object. Here, the driving control apparatus for a moving object is configured to include: a wire having one end accommodated inside the driving control apparatus and the other end extending to an outside of the driving control apparatus, and fixed to a predetermined location of a user, the wire having a tension in accordance with a movement of the user, and being wound or unwound in the form of a straight line; and a control signal generation unit configured to generate a control signal for a driving control of the moving object.

In an embodiment, the control signal generation unit may be configured to: generate the control signal for controlling the moving object so that the moving object is driven while keeping a predetermined separation distance range from the user based on an unwinding length and an unwinding angle of the wire; and transfer the generated control signal to a driving device of the moving object.

In an embodiment, the driving control apparatus for a moving object may further include a driving mode determination unit configured to determine any one of one or more predefined driving modes before the driving of the moving object.

In an embodiment, in each of the one or more driving modes, a location relationship between the moving object and the user may be defined.

In an embodiment, the driving mode may be configured to include: at least one of a front driving mode in which the moving object is driven in front of the user; a rear driving mode in which the moving object is driven in the rear of the user; a right horizontal driving mode in which the moving object is driven side by side on a right side of the user; and a left horizontal driving mode in which the moving object is driven side by side on a left side of the user.

In an embodiment, the control signal generation unit may be configured to generate the control signal for controlling the moving object so that the moving object is driven while keeping the location relationship defined in the determined driving mode and the separation distance range.

In an embodiment, the driving mode determination unit may be configured to determine any one of a plurality of driving modes based on a driving mode selection signal input by the user.

In an embodiment, the driving control apparatus for a moving object may be configured to further include a rotation sensor configured to sense a rotation direction of the driving control apparatus for a moving object, wherein the driving mode determination unit is configured to determine any one of a plurality of driving modes based on the rotation direction sensed by the rotation sensor.

In an embodiment, the driving control apparatus for a moving object may be configured to further include a fixed location sensor configured to sense a location where the driving control apparatus for a moving object is combined with the moving object, wherein the driving mode determination unit is configured to determine any one of a plurality of driving modes based on the combination location sensed by the fixed location sensor.

In an embodiment, the control signal generation unit may be configured to: define a reference location of the user in accordance with the determined driving mode, derive location information of the user based on the reference location every predetermined time unit based on an unwinding length and an unwinding angle of the wire being changed in accordance with the movement of the user, and generate the control signal based on the derived location information of the user.

In an embodiment, the control signal may include at least one of a speed control signal and a steering control signal of the moving object.

### Advantageous Effects

The driving control apparatus for a moving object according to the present disclosure can easily control the moving object that transfers a relatively small and lightweight object, such as a shopping cart or a stroller, and can be implemented at low costs as well.

Further, the driving control apparatus for a moving object according to the present disclosure can control the moving object to be driven while keeping a predetermined distance from a user.

Further, the driving control apparatus for a moving object according to the present disclosure can provide various driving modes in which a location relationship between a user and the moving object is defined, and can easily control the moving object in accordance with the driving mode selected by the user.

### DESCRIPTION OF DRAWINGS

FIG. 1 is a reference diagram explaining a driving control apparatus for a moving object according to the present disclosure.

FIG. 2 is a reference diagram explaining a wire according to an embodiment of the present disclosure.

FIG. 3 is a block diagram explaining constituent elements of a driving control apparatus for a moving object according to an embodiment of the present disclosure.

FIG. 4 is a reference diagram explaining a length calculator and an angle calculator according to an embodiment of the present disclosure.

FIG. 5 is a reference diagram explaining a length calculator and an angle calculator according to another embodiment of the present disclosure.

FIG. 6 is a reference diagram explaining a method for generating a control signal according to an embodiment of the present disclosure.

FIGS. 7A to 8B are reference diagrams explaining a driving mode according to an embodiment of the present disclosure.

FIGS. 9A and 9B are reference diagrams explaining an operation of a driving mode determination unit according to an embodiment of the present disclosure.

FIGS. 10A to 10C are reference diagrams explaining a method for generating a control signal in case that a right horizontal driving mode is set according to an embodiment of the present disclosure.

[Explanation of symbols]

| | |
|---|---|
| 10: | moving object |
| 11: | driving device |
| 20: | user apparatus for a moving object |
| 100: | driving control |
| 110: | wire |
| 111: | user fixing device generation unit |
| 120: | control signal |
| 121: | length calculator |
| 122: | angle calculator |
| 123: | location calculator |
| 124: | signal generator determination unit selection button |
| 130: | driving mode |
| 131: | driving mode |
| 132: | rotation sensor |
| 133: | fixed location sensor |
| 211: | rotation member |
| 212 : | rotation amount measurement sensor |
| 221: | rotation member measurement sensor |
| 222: | rotation angle |
| 311: | rotation member |
| 312: | rotation amount measurement sensor |
| 321: | sliding member measurement sensor |
| 322: | rotation angle |

### MODE FOR INVENTION

The detailed explanation of the present disclosure is to completely explain the present disclosure to those of ordinary skill in the art. In the whole specification, in case that a certain part is described to “include” a certain constituent element, or to be “characterized” by a certain structure and shape, unless specially described on the contrary, it does not mean that other constituent elements are excluded or other structures and shapes are excluded, but it means that other constituent elements, structures, and shapes may be included.

Further, the “. . . term unit” described in the specification means a unit to process one or more functions or operations, and may be implemented as hardware, software, or a combination of the hardware and the software.

The present disclosure may have various modifications and several embodiments, and a specific embodiment will be presented and explained in detail in the detailed description. However, it should be understood that the contents of the present disclosure are not limited by the embodiment, but the present disclosure includes all modifications, equivalents, and substitutions included in the idea and the technical range of the present disclosure.

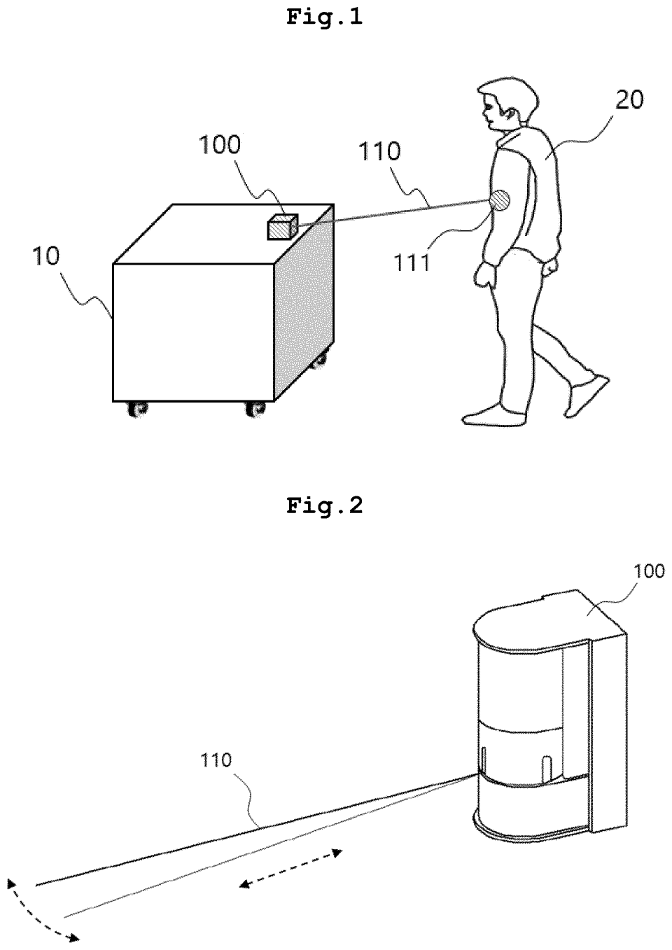

Hereinafter, a driving control apparatus for a moving object according to the present disclosure and various embodiments of the present disclosure will be described in detail with reference to FIGS. 1 to 10C.

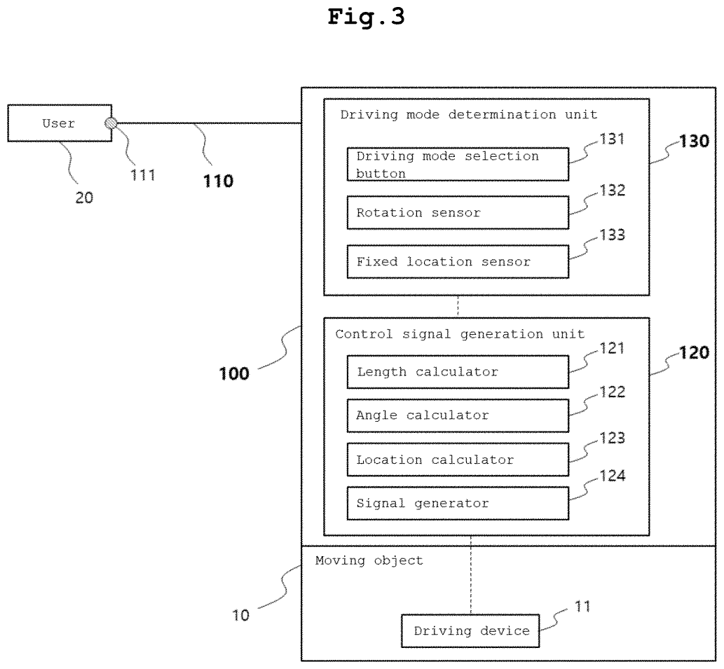

FIG. 1 is a reference diagram explaining a driving control apparatus for a moving object according to the present disclosure, FIG. 2 is a reference diagram explaining a wire according to an embodiment of the present disclosure, and FIG. 3 is a block diagram explaining constituent elements of a driving control apparatus for a moving object according to an embodiment of the present disclosure.

Referring to FIG. 1, a driving control apparatus 100 for a moving object according to the present disclosure is an apparatus which may be fixed to a predetermined location of a moving object 10, and may generate a control signal for controlling driving of the moving object 10. Here, the driving control apparatus 100 for a moving object may be configured to include a housing that can accommodate a plurality of constituent elements therein.

In an embodiment, the moving object 10 may mean a device which includes wheels provided on a bottom surface thereof for location movement, and a driving device 11 configured to control driving of the wheels. Here, the moving object 10 may correspond to a transfer means for transferring a specific object, and for example, may correspond to a cart, a stroller, or a carrier provided with the driving device. Meanwhile, such an example is not intended to limit the scope of the present disclosure, but any device should be interpreted as the moving object 10 according to the present disclosure as long as the location of the device may be moved by the driving device even if the device may not transfer goods.

In an embodiment, the driving control apparatus 100 for a moving object may be configured to include a fixing device (not illustrated) for fixed combination with the moving object 10. Here, the fixing device may be implemented by various known devices, such as a ring member, a clamp member, and an adhesive member.

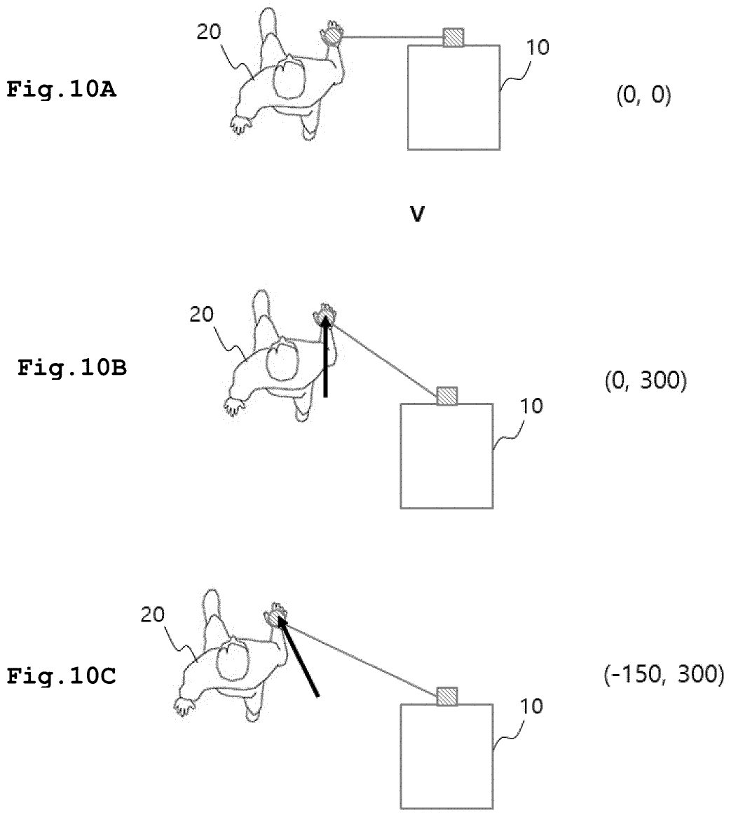

In an embodiment, the driving control apparatus 100 for a moving object may be fixed to any one location of front, rear, left, and right based on a movement direction of the moving object 10. For example, as illustrated in FIG. 1, the driving control apparatus 100 for a moving object may be fixed to a rear side of an upper surface of the moving object 10. As another example, as illustrated in FIG. 10A to 10C, the driving control apparatus 100 for a moving object may be fixed to a front surface of the moving object 10.

Meanwhile, it should be interpreted that an accurate location where the driving control apparatus 100 for a moving object is combined with the moving object 10 and a method for combining the driving control apparatus 100 for a moving object with the moving object 10 are not limited, but may be modified in various ways. For example, in case that the moving object 10 corresponds to the stroller, the driving control apparatus 100 for a moving object may be combined with a handle part formed on the rear side of the stroller.

Referring to FIG. 2, the driving control apparatus 100 for a moving object according to the present disclosure may be configured to include a wire 110 having a predetermined tension and extending in a length direction. Here, one end of the wire 110 may be accommodated inside the driving control apparatus 100 for a moving object, and the other end thereof may extend to an outside of the driving control apparatus 100 for a moving object and may be fixed to a predetermined location of a user 20.

In an embodiment, a user fixing device 111 for being fixed to the predetermined location of the user 20 may be provided at the other end of the wire 110. Here, the user fixing device 111 may be implemented by various known devices, such as a ring member, a clamp member, or an adhesive member, and may be formed in a predetermined shape that can be grasped by the user.

In an embodiment, the other end of the wire 110 may be fixed to the clothing worn by the user 20 through the user fixing device 111. In another embodiment, since the user fixing device 111 is grasped by the user, the other end of the wire 110 may be fixed to the hand of the user 20.

The wire 110 may have a tension in accordance with the movement of the user 20, and may be wound or unwound in the form of a straight line. The driving control apparatus 100 for a moving object may generate a control signal for controlling the driving of the moving object 10 based on an unwinding length and an unwinding angle of the wire 110 that may be changed in accordance with the movement of the user 20.

Referring to FIG. 3, the driving control apparatus 100 for a moving object according to the present disclosure may be configured to include the wire 110, a control signal generation unit 120, and a driving mode determination unit 130. Here, the control signal generation unit 120 and the driving mode determination unit 130 may each be provided with a memory for data storage and a processor for data processing, and may perform a driving control method for a moving object to be described hereinafter.

The control signal generation unit 120 may generate the control signal for the driving control of the moving object 10. Here, the control signal generation unit 120 may generate the control signal for controlling the moving object 10 based on the unwinding length and the unwinding angle of the wire 110, and may transfer the generated control signal to the driving device 11 of the moving object 10.

In an embodiment, the control signal generation unit 120 may generate the control signal for controlling the moving object 10 so that the moving object 10 is driven while keeping a predetermined separation distance range from the user 20. For example, in case that the separation distance between the moving object 10 and the user 20 is set to 1 m, and an error range is set to 0.2 m, the control signal generation unit 120 may generate the control signal for controlling the moving object 10 so that the moving object 10 is driven while keeping 0.9 to 1.1 m from the user 20.

Hereinafter, a process in which the control signal generation unit 120 according to the present disclosure generates the control signal will be described in detail.

Referring to FIG. 3, the control signal generation unit 120 may be configured to include a length calculator 121, an angle calculator 122, a location calculator 123, and a signal generator 124.

The length calculator 121 may calculate the unwinding length of the wire 110 that is wound or unwound in accordance with the movement of the user. For this, the length calculator 121 may be configured to include rotation members 211 and 311 and rotation amount measurement sensors 212 and 312.

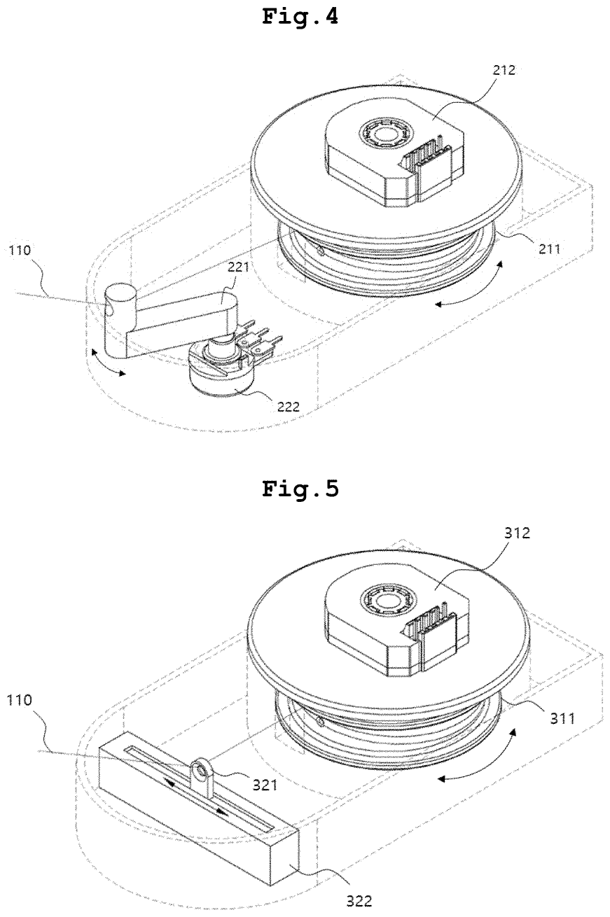

In an embodiment, as illustrated in FIGS. 4 and 5, each of the rotation members 211 and 311 may be formed in a cylindrical shape, may be connected to one end of the wire 110, and may be configured so that the wire 110 is wound or unwound on an outside of each of the rotation members 211 and 311. Here, in case that the rotation members 211 and 311 are rotated in any one direction between a clockwise direction and a counterclockwise direction, the wire 110 may be unwound from the rotation members 211 and 311, and in case that the rotation members 211 and 311 are rotated in the other direction, the wire 110 may be wound. In an embodiment, an elastic member (e.g., spring or the like) may be provided on an inside of each of the rotation members 211 and 311 and may make the wire 110 keep a predetermined tension to correspond to the movement of the user.

In an embodiment, the rotation amount measurement sensors 212 and 312 may be connected to the rotation members 211 and 311, respectively, and may measure the amount of rotation of the rotation members 211 and 311, respectively, due to the winding or unwinding of the wire 110. Here, each of the rotation amount measurement sensors 212 and 312 may correspond to a potentiometer that outputs a voltage in proportion to the amount of rotation in a manner that, when the rotating shaft thereof is rotated in accordance with the change of rotation displacement thereof, an inner wiper thereof moves over a resistor.

In an embodiment, the length calculator 121 may calculate the unwinding length of the wire 110 in proportion to the amount of rotation of each of the rotation members 211 and 311 measured by the rotation amount measurement sensors 212 and 312.

The angle calculator 122 may calculate the unwinding angle of the wire 110 that is wound or unwound in accordance with the movement of the user. For this, the angle calculator 122 may be configured to include a rotation member 221 or a sliding member 321 and rotation angle measurement sensors 222 and 322.

In an embodiment, as illustrated in FIG. 4, the rotation member 221 may be configured to be penetrated by the wire 110 and to be rotated to correspond to the winding or unwinding angle of the wire 110. Here, the rotation angle measurement sensor 222 may be connected to the rotation member 221, and may measure the rotation angle of the rotation member 221 due to the change of the unwinding angle of the wire 110. The rotation angle measurement sensor 222 may correspond to an encoder that measures the amount of rotation by counting the number of grooves being passed as a rotation encoder ring in which the grooves are formed at equal intervals is rotated together with the rotation member 221.

In another embodiment, as illustrated in FIG. 5, the sliding member 321 may be configured to be penetrated by the wire 110, and to slide to correspond to the winding or unwinding angle of the wire 110. Here, the rotation angle measurement sensor 322 may be connected to the rotation member 321 and may measure the rotation angle based on the movement distance of the sliding member 321 due to the change of the unwinding angle of the wire 110.

Meanwhile, the above-described embodiment of the configuration for calculating the unwinding length and the unwinding angle of the wire 100 is not intended to limit the scope of the present disclosure, and of course, the configuration for calculating the unwinding length and the unwinding angle of the wire 110 may be implemented by a different method from the above-described embodiment.

The location calculator 123 may derive location information of the user 20 every predetermined time unit based on the unwinding length and the unwinding angle of the wire 110 that are changed in accordance with the movement of the user 20. Here, the time unit for deriving the location information may correspond to the time unit for generating the control signal, and may be set to, for example, 20 ms.

In an embodiment, the location calculator 123 may derive the location information of the user 20 by using a unwinding length Sl calculated by the length calculator 121 and a unwinding angle Sa calculated by the angle calculator 122. Here, the location information of the user 20 may correspond to coordinate information defined in the x-y Cartesian coordinate system.

In an embodiment, the location calculator 123 may calculate the location information of the user 20 by using Mathematical Expression 1 below.

(x,y)=(Sl*cos(Sa),Sl*sin(Sa)) [Mathematical Expression 1]

Here, the center of coordinates may be defined as the location of the driving control apparatus 100 for a moving object or the other end of the wire 110, that is, the location of the user 20.

The signal generator 124 may generate the control signal for controlling the moving object 10 based on the unwinding length Sl and the unwinding angle Sa of the wire 110. Here, the signal generator 124 may generate the control signal for controlling the moving object 10 so that the moving object 10 is driven while keeping the predetermined separation distance range from the user 20.

In an embodiment, the control signal may include at least one of a speed control signal and a steering control signal of the moving object 10.

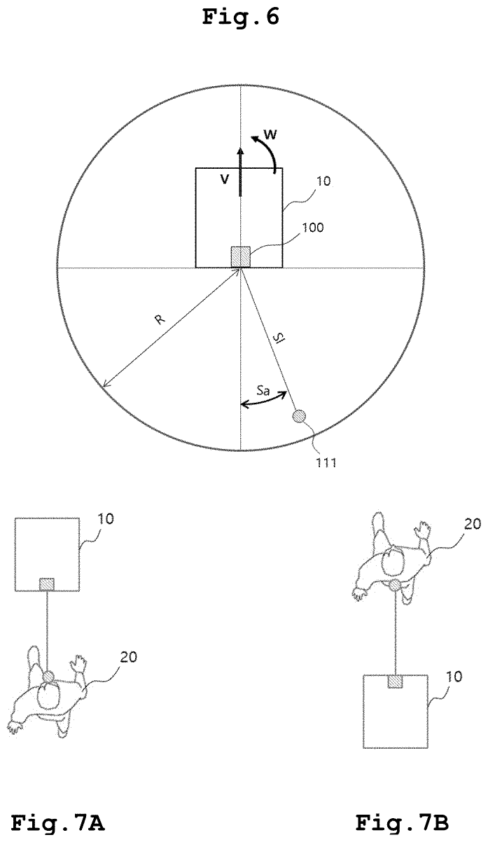

More specifically, referring to FIG. 6, in case that the separation distance between the moving object 10 and the user 20 is set to R, the signal generator 124 may generate the control signal for controlling the moving object 10 so that the moving object 10 is driven while keeping the distance R from the user 20 based on the unwinding length Sl and the unwinding angle Sa of the wire 110. In an embodiment, the signal generator 124 may generate the control signal by using Mathematical Expression 2 below.

V=(R−Sl)*Vg [Mathematical Expression 2]

W=Sa*Wg

(V: speed of the moving object, W: angular velocity of the moving object, R: separation distance, Sl: unwinding length, Sa: unwinding angle, Vg: speed gain, and Wg: angle gain)

For example, in case that the moving object 10 is set to be driven while keeping 1 m distance (R) in front of the user 20, the signal generator 124 may identify the unwinding length Sl and the unwinding angle Sa every 20 ms, and may generate the control signal for controlling the driving device 11 of the moving object 10 every time unit based on Mathematical Expression 2 above. Referring to FIG. 6 and Mathematical Expression 2, if the user's location gets closer than R (i.e., if the unwinding length becomes shorter than R), the signal generator 124 may calculate a speed control signal V for moving the moving object 10 forward, and may transfer the speed control signal V to the driving device 11. Further, if the user's location moves to the right, the signal generator 124 may calculate a steering control signal W for moving the moving object 10 to the left, and may transfer the steering control signal W to the driving device 11. Through such an operation of the signal generator 124, the moving object 10 can be driven while keeping the predetermined separation distance range from the user 20.

In an embodiment, the signal generator 124 may generate the control signal based on the location information of the user 20 calculated by the location calculator 123. More specifically, the signal generator 124 may calculate the speed and steering control signals by using Mathematical Expression 2 above in which the unwinding length Sl and the unwinding angle Sa are variables, and unlike this, the signal generator 124 may calculate the speed and steering control signals by putting the location coordinate of the user 20, derived based on the unwinding length Sl and the unwinding angle Sa, as variables.

Hereinafter, a method in which the driving control apparatus 100 for a moving object according to an embodiment of the present disclosure generates a control signal in accordance with various driving modes will be described.

Referring to FIG. 3, the driving control apparatus 100 for a moving object may be configured to include the driving mode determination unit 130 that determines any one of one or more predefined driving modes before the driving of the moving object 10.

In an embodiment, in the driving mode, the location relationship between the moving object 10 and the user 20 may be defined. Here, the driving mode may be configured to include at least one of a front driving mode, a rear driving mode, a right horizontal driving mode, and a left horizontal driving mode.

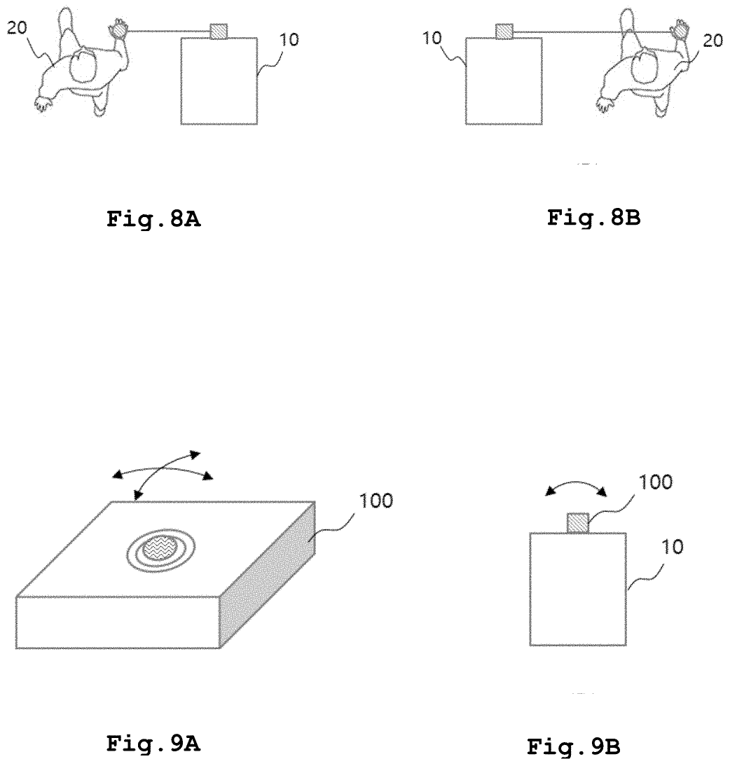

The driving mode according to the present disclosure will be described in more detail with reference to FIGS. 7A to 8B. FIGS. 7A to 8B are reference diagrams explaining driving modes according to an embodiment of the present disclosure.

Referring to FIG. 7A, the front driving mode may be defined so that the moving object 10 is driven in front of the user 20. That is, the front driving mode is a mode in which the user 20 is located in the rear of the moving object 10, and if the user 20 moves forward, the unwinding length of the wire 110 is shortened to control the moving object 10 to move forward, and thus the moving object 10 is driven while keeping a predetermined separation distance from the user 20 in front of the user 20. Here, if the user moves to the right, the moving object 10 is controlled to steer to the left to correspond to the change of the unwinding angle of the wire 110, and thus the moving object 10 can move to the front of the user 20 and be driven.

Referring to FIG. 7B, the rear driving mode may be defined so that the moving object 10 is driven in the rear of the user 20. That is, the rear driving mode is a mode in which the user 20 is located in front of the moving object 10, and if the user 20 moves forward, the unwinding length of the wire 110 is lengthened to control the moving object 10 to move forward, and thus the moving object 10 is driven while keeping a predetermined separation distance from the user 20 in the rear of the user 20. Here, if the user moves to the left, the moving object 10 is controlled to steer to the right to correspond to the change of the unwinding angle of the wire 110, and thus the moving object 10 can move to the rear of the user 20 and be driven.

Referring to FIG. 8A, the right horizontal driving mode may be defined so that the moving object 10 is driven side by side on the right side of the user 20. That is, the right horizontal driving mode is a mode in which the user 20 is located on the left side of the moving object 10, and if the user 20 moves forward, the moving object 10 is controlled to move forward to correspond to the change of the unwinding length and angle of the wire 110, and thus the moving object 10 is driven side by side while keeping a predetermined separation distance from the user 20 on the right side of the user 20.

Referring to FIG. 8B, the left horizontal driving mode may be defined so that the moving object 10 is driven side by side on the left side of the user 20. That is, the left horizontal driving mode is a mode in which the user 20 is located on the right side of the moving object 10, and if the user 20 moves forward, the moving object 10 is controlled to move forward to correspond to the change of the unwinding length and angle of the wire 110, and thus the moving object 10 is driven side by side while keeping a predetermined separation distance from the user 20 on the left side of the user 20.

In an embodiment, the driving mode determination unit 130 may determine any one of a plurality of driving modes based on a driving mode selection signal input by the user 20.

In an embodiment, the driving mode determination unit 130 may be configured to include a driving mode selection button 131 that can be manipulated by the user. For example, as illustrated in FIG. 9A, the driving mode selection button 131 may be provided on an upper part of the driving control apparatus 100 for a moving object, and the driving mode selection button 131 may be manipulated by the user. Here, the driving mode determination unit 130 may determine the driving mode corresponding to the driving mode selection signal output from the driving mode selection button 131. The upper side, the lower side, the right side, and the left side of the driving mode selection button 131 may be defined as the front driving mode, the lower driving mode, the right horizontal driving mode, and the left horizontal driving mode, respectively.

In an embodiment, the driving mode determination unit 130 may receive the driving mode selection signal from a user terminal (e.g., smart phone) that is manipulated by the user 20. Here, the driving mode determination unit 130 may determine the driving mode corresponding to the received driving mode selection signal.

In an embodiment, the driving mode determination unit 130 may determine any one of a plurality of driving modes based on the rotation direction of the driving control apparatus 100 for a moving object. Here, the driving mode determination unit 130 may be configured to further include a rotation sensor 132 that senses the rotation direction of the driving control apparatus 100 for a moving object.

For example, as illustrated in FIG. 9B, the user may select the driving mode by fixing the driving control apparatus 100 for a moving object to the front of the moving object 10, and by rotating the driving control apparatus 100 for a moving object in a specific direction. Here, if the driving control apparatus 100 for a moving object is rotated to the left, the driving mode determination unit 130 may determine the left horizontal driving mode as the driving mode, whereas if the driving control apparatus 100 for a moving object is rotated to the right, the driving mode determination unit 130 may determine the right horizontal driving mode as the driving mode.

In an embodiment, the driving mode determination unit 130 may determine any one of the plurality of driving modes based on a combination location sensed by a fixed location sensor. Here, the driving mode determination unit 130 may be configured to further include the fixed location sensor that senses the location at which the driving control apparatus 100 for a moving object is combined with the moving object 10.

In an embodiment, the fixed location sensor may be implemented as at least one contact sensor installed on the side surface of the driving control apparatus 100 for a moving object. Here, the driving mode determination unit 130 may determine the driving mode based on the contact direction of the driving control apparatus 100 for a moving object. For example, if it is sensed that the front surface of the driving control apparatus 100 for a moving object comes into contact with the moving object 10, the driving mode determination unit 130 may determine that the driving control apparatus 100 for a moving object is fixed to the rear side of the moving object 10, and may determine the front driving mode as the driving mode. As another example, if it is sensed that the left surface of the driving control apparatus 100 for a moving object comes into contact with the moving object 10, the driving mode determination unit 130 may determine that the driving control apparatus 100 for a moving object is fixed to the right side of the moving object 10, and may determine the right horizontal driving mode as the driving mode.

In an embodiment, if a specific driving mode is determined by the driving mode determination unit 130, the control signal generation unit 120 may generate the control signal for controlling the moving object 10 so that the moving object 10 is driven while keeping the location relationship defined in the determined driving mode and the predetermined separation distance range. The present embodiment will be described in more detail with reference to FIG. 10A to 10C.

For example, if the user 20 fixes the driving control apparatus 100 for a moving object to the front of the moving object 10, and rotates the driving control apparatus 100 for a moving object in a rightward direction, the driving mode determination unit 130 may determine the right horizontal driving mode as the driving mode by sensing the rotation direction through the rotation sensor 132. Here, if the separation distance is set to 1 m, the control signal generation unit 120 may identify the unwinding length Sl and the unwinding angle Sa every time unit with the left point of 1000 mm of the driving control apparatus 100 for a moving object as the reference location (refer to FIG. 10A). Here, if the user 20 moves forward by 300 mm (refer to FIG. 10B), the control signal generation unit 120 may calculate the speed control signal V for moving the moving object 10 forward by 300 mm, and may transfer the speed control signal V to the driving device 11. If the user 20 moves forward by 300 mm and left by 150 mm (refer to FIG. 10C), the control signal generation unit 120 may calculate the speed control signal V and the steering control signal W for moving the moving object 10 forward by 300 mm and left by 150 mm, and may transfer the speed control signal V and the steering control signal W to the driving device 11. Through the above operation of the control signal generation unit 120, the moving object 10 can be driven while keeping the location relationship defined in the driving mode and the predetermined separation distance range from the user 20.

The driving control apparatus 100 for a moving object according to the present disclosure can control the moving object 10 to be driven while automatically keeping the predetermined distance from the user 20, and can control the moving object 10 to be driven at the location desired by the user 20, thereby greatly improving the convenience of the user 20. Further, since the present disclosure can calculate the location of the user 20 by using the wire 110 connected to the user 20, and can control the moving object 10 based on the calculated location, the apparatus 100 can be implemented at low costs as compared with that in the related art.

Although the present disclosure has been described with reference to the preferred embodiments, it can be understood by those skilled in the art to which the present disclosure pertains that the present disclosure can be variously changed and modified within a range that does not deviate from the idea and region of the present disclosure described in the appended claims.

1. A driving control apparatus for a moving object, which can be fixed to a predetermined location of the moving object, the driving control apparatus comprising:
a wire having one end accommodated inside the driving control apparatus and the other end extending to an outside of the driving control apparatus, and fixed to a predetermined location of a user, the wire having a tension in accordance with a movement of the user, and being wound or unwound in the form of a straight line; and
a control signal generation unit configured to generate a control signal for a driving control of the moving object,
wherein the control signal generation unit is configured to: generate the control signal for controlling the moving object so that the moving object is driven while keeping a predetermined separation distance range from the user based on an unwinding length and an unwinding angle of the wire; and transfer the generated control signal to a driving device of the moving object.

2. The driving control apparatus of claim 1, further comprising a driving mode determination unit configured to determine any one of one or more predefined driving modes before the driving of the moving object.

3. The driving control apparatus of claim 2, wherein in each of the one or more driving modes, a location relationship between the moving object and the user is defined.

4. The driving control apparatus of claim 3, wherein the driving mode is configured to include at least one of:
a front driving mode in which the moving object is driven in front of the user;
a rear driving mode in which the moving object is driven in the rear of the user;
a right horizontal driving mode in which the moving object is driven side by side on a right side of the user; and
a left horizontal driving mode in which the moving object is driven side by side on a left side of the user.

5. The driving control apparatus of claim 3, wherein the control signal generation unit is configured to generate the control signal for controlling the moving object so that the moving object is driven while keeping the location relationship defined in the determined driving mode and the separation distance range.

6. The driving control apparatus of claim 2, wherein the driving mode determination unit is configured to determine any one of a plurality of driving modes based on a driving mode selection signal input by the user.

7. The driving control apparatus of claim 2, further comprising a rotation sensor configured to sense a rotation direction of the driving control apparatus for a moving object,
wherein the driving mode determination unit is configured to determine any one of a plurality of driving modes based on the rotation direction sensed by the rotation sensor.

8. The driving control apparatus of claim 2, further comprising a fixed location sensor configured to sense a location where the driving control apparatus for a moving object is combined with the moving object,
wherein the driving mode determination unit is configured to determine any one of a plurality of driving modes based on the combination location sensed by the fixed location sensor.

9. The driving control apparatus of claim 5, wherein the control signal generation unit is configured to:
define a reference location of the user in accordance with the determined driving mode,
derive location information of the user based on the reference location every predetermined time unit based on an unwinding length and an unwinding angle of the wire being changed in accordance with the movement of the user, and
generate the control signal based on the derived location information of the user.

10. The driving control apparatus of claim 1, wherein the control signal includes at least one of a speed control signal and a steering control signal of the moving object.
